(19) United States
(12) Patent Application Publication
(10) Pub. No.: US 2014/0035840 A1
(43) Pub. Date: Feb. 6, 2014

(54) DEVICE FOR REPRODUCING HANDWRITING, TABLET BELONGING TO SUCH A DEVICE AND METHOD FOR USING SUCH A DEVICE

(71) Applicants: Gerard Guerin, Lyon (FR); Alexia Raulin, Lyon (FR); Gerard Guyard, Lyon (FR)

(72) Inventors: Gerard Guerin, Lyon (FR); Alexia Raulin, Lyon (FR); Gerard Guyard, Lyon (FR)

(73) Assignee: GRAVOTECH MARKING, Rillieux-la-Pape (FR)

(21) Appl. No.: 13/701,958

(22) PCT Filed: Jun. 1, 2011
(86) PCT No.: PCT/FR2011/051263

§ 371 Date: Mar. 18, 2013

(30) Foreign Application Priority Data
Jun. 4, 2010 (FR) 1054412

(51) Int. Cl. G06F 3/0488

(52) U.S. Cl. CPC G06F 3/04883
USPC 345/173

(57) ABSTRACT

A device for reproducing handwriting, comprising handwriting acquisition means. When a user writes on the handwriting acquisition means with a writing means, a handwriting trace is recorded in the form of a digital trace. The writing means is provided with a tip, a writing tablet has a frame and an active surface which is disposed in the frame and which records the handwriting trace in the form of a digital trace, at least one sheet reacting locally to pressure from the tip, and means for maintaining the sheet in position against the active surface. The device includes processing means to subject the digital trace to at least one processing operation to obtain a transformed trace and writing restitution means having an apparatus provided with a marking tool and configured to restitute the set of data processed by the processing means by marking the transformed trace on a substrate.

### CROSS-REFERENCE TO RELATED APPLICATION

This application is the National Stage of International Application No. PCT/FR2011/051263 (“the '263 PCT”) filed Jun. 1, 2011. The '263 PCT published on Dec. 8, 2011 as WO/2011/151604. The '263 PCT claims priority to French Application No. 1054412 filed Jun. 4, 2010. Both applications are incorporated herein by reference in their entirety.

### BACKGROUND

The present invention relates to a device for reproducing handwriting. The invention also relates to a writing tablet belonging to such a device, and a method for implementing such a device. The field of the invention is that of systems for reproducing handwriting.

In a known manner, a graphic tablet has an active surface that is capable of recording a stimulus, in particular the pressure exerted by writing means. Such a tablet may assume various configurations, with different types of active surfaces and writing means. In particular, the writing means may be a manual implement such as a stylus, or the user's fingers directly. In this way, the user can write or draw on the tablet, i.e. trace the writing manually by managing the pressure and movement of the writing means on the active surface.

Furthermore, different types of active surface exist. The active surface may be an opaque plate that records the trace of the writing, while the viewing may be done only on the screen of a monitor. In that case, to follow the trace of the writing, the user is required to look at the monitor without watching his hand on the tablet, which is not practical. Furthermore, a shift may occur between the gesture and the display of the trace on the monitor, which can be disconcerting for the user.

Alternatively, the tablet can have a screen that itself constitutes the active surface, which makes it possible to regain the natural coordination between the look, the gesture of the hand, and the writing medium. However, writing directly on the screen may destabilize a non-specialized user, for example a child or an elderly person. Certain tablets do not include a frame, and the user may accidentally press on the active surface of the screen. Thus, the existing writing tablets are not satisfactory.

As known from U.S. Publication No. 2007/126716, the tablet may be connected to a computer, thereby forming a device capable of recording the user's handwriting so that it may be processed and used later.

The existing tablets are not practical for the user and do not make it possible to reproduce the handwriting with optimal quality, as its trace is deformed. The existing devices are not suitable for the acquisition, processing, and reproduction of handwriting with sufficient quality and user comfort.

The aim of the present invention is therefore to provide a device for reproducing handwriting that is high-performing, simple, and practical to use.

### SUMMARY

To that end, the invention relates to a device for reproducing handwriting, having handwriting acquisition means recording, when a user writes on the handwriting acquisition means with writing means, a handwriting trace in the form of a set of data including coordinates of points of a digital trace, said handwriting acquisition means comprising at least one writing kit including: the writing means provided with a tip, a writing tablet comprising a frame and an active surface which is disposed in the frame and which records the handwriting trace in the form of a set of data corresponding to the digital trace when a user writes on the tablet with the writing means, at least one sheet adapted to react locally to pressure from the tip, and maintaining means for maintaining the sheet in the use position against the surface.

The device includes:
processing means configured to subject the set of data corresponding to the digital trace to at least one processing operation in order to obtain a transformed trace, and
writing restitution means comprising an apparatus provided with a marking tool and configured to restitute the set of data processed by the processing means by marking the transformed trace on a substrate.

The device thus makes it possible to record the handwriting of the user, process the recorded trace, then etch the trace of the writing on an object using a marking device in order to customize object. The invention makes it possible to improve the user comfort, simplicity of use, and versatility of the device. The writing kit offers a non-specialized user, for example a child or an elderly person, or several successive users, the possibility of writing simply and practically, while monitoring the trace of the writing directly on the writing support. In fact, by combining the tablet provided with an active surface arranged in a frame and the support for receiving a removable sheet of paper, it is possible for the user to write and view the trace of the writing in real-time, without being forced to write and read on the active surface of the tablet. Owing to the processing means configured to that end, the device according to the invention is provided to apply processing to the recorded writing, in particular real-time smoothing. The device thus makes it possible to reproduce the handwriting with improved quality, or even to customize the transformed trace.

Preferably, a sheet of paper is positioned kept against the active surface of the tablet to facilitate writing and reading by the user. However, it remains possible to write directly on the active surface if the user is comfortable with that writing method, or if no sheet is available temporarily. In other words, the trace of the writing is visible on the sheet in the form of a handwriting trace or, in the absence of the sheet, on the active surface in the form of a digital trace.

According to other features of the invention, considered alone or in combination:
the maintaining means comprise a medium arranged on the tablet, the medium extending around the active surface over at least part of the frame and being able to maintain the sheet in the use position against the active surface;
the support is made from a deformable material, in particular elastomer, and delimits, with the frame, at least one housing for receiving an edge of the sheet and maintaining the sheet in the use position against the active surface;
the support comprises at least one deformable lip bearing against the frame and/or the active surface and that can be at least partially moved away from the frame and/or the active surface for the insertion of one edge of the sheet between said lip and the frame and/or the active surface;
the maintaining means comprise several studs arranged on the tablet, and the sheet has perforations complementary to the studs;
the maintaining means comprise at least one clamp arranged on the tablet and/or at least one self-adhesive surface arranged on the sheet and/or several studs arranged on the tablet while the sheet has perforations complementary to the studs;
the processing means comprise a smoothing algorithm for a profile drawn by the coordinates of points making up for digital trace without eliminating points;
the writing restitution means are capable of receiving different types of substrates, in particular having different shapes and/or different dimensions;
the writing restitution means comprise one of the following tools: drill, scratching tip, micro-striker, laser, ultrasonic stylus, heating tip for hot marking, heating tip associated with a heat transfer strip, sewing machine needle or printer pins;
the writing restitution means comprise a system for automatically detecting the dimensions and/or position of the substrate.

According to one alternative embodiment, the writing means do not release a visible substance and the sheet is a self-copying paper, such that, when the user writes with the writing means on a sheet positioned in the tablet, the bearing pressure of the writing means on the sheet releases a substance initially included in the sheet that shows the trace of the writing on the sheet.

According to another alternative embodiment, each sheet is made from a non-self-copying paper and the writing means can release a visible substance, such that when a user writes with the writing means on a sheet positioned in the tablet, the bearing pressure of the writing means on the sheet releases a substance initially included in the writing means that shows the trace of the writing on the sheet.

Furthermore, the invention relates to a writing tablet provided with an active surface that is positioned in a frame and that records a handwriting trace in the form of a set of data corresponding to a digital trace when a user writes on the tablet with writing means. This tablet belongs to a writing kit of a handwriting reproduction device as mentioned above and also comprises a support, which extends around the active surface over at least part of the frame and is capable of maintaining a sheet in the in use position against the active surface.

Additionally, the invention relates to a method for implementing a handwriting reproduction device, comprising writing acquisition means, processing means, and writing restitution means, the method including the following steps:
a) a writing step, in which the user writes on the writing acquisition means using writing means, and at the same time views the trace of the writing on the writing acquisition means,
b) a writing acquisition step, in which the writing acquisition means record the trace of the writing in the form of a set of data that includes coordinates for points corresponding to the digital trace, the acquisitions being carried out at the same time as the writing step a),
c) a processing step, in which the data set corresponding to the digital trace undergoes at least one processing operation to obtain a transformed trace, and
d) a writing reproduction step, in which the writing restitution means perform marking of the transformed trace on the substrate.

Preferably, the method according to the invention is implemented with the aforementioned device. Alternatively, the method according to the invention may be implemented with any type of writing reproduction device, comprising writing acquisition means, processing means, and writing restitution means specifically configured to reproduce a handwritten trace.

The processing of step c) comprises smoothing, resizing, reframing, duplication, a fantastical effect, or a combination of at least some of the above.

Alternatively, the step c) on the one hand comprises automatic smoothing processing that is done at the same time as steps a) and b) and, on the other hand, at least one processing operation chosen by the user.

### BRIEF DESCRIPTION OF THE DRAWINGS

The invention will be better understood upon reading the following description, provided solely as a non-limiting example and done in reference to the drawings, in which:

FIG. 1 is an exploded perspective view of a writing kit adapted to equip a handwriting reproduction device according to the invention, the kit comprising a writing tablet, writing means, and a sheet;

FIG. 2 is a front view of the writing tablet, associated with the writing means and the sheet of FIG. 1;

FIG. 3 is a front view of the sheet included in the writing kit and designed to equip the writing tablet of FIGS. 1 and 2;

FIG. 4 is a perspective view of a support for retaining the sheet of FIGS. 1 to 3, equipping the writing tablet of FIGS. 1 and 2;

FIGS. 5 and 6 are respectively a top view and a bottom view of the support of FIG. 4;

FIGS. 7 and 8 are cross-sections, respectively along arrows VII-VII and VIII-VIII of FIG. 5;

FIG. 9 is a cross-section corresponding to detail IX in FIG. 8, when the support is in place on the graphic tablet and immobilizes a sheet;

FIG. 10 is a block diagram of a handwriting reproduction device according to the invention; and

FIG. 11 is a front view of an object marked using the device of FIG. 10.

### DETAILED DESCRIPTION

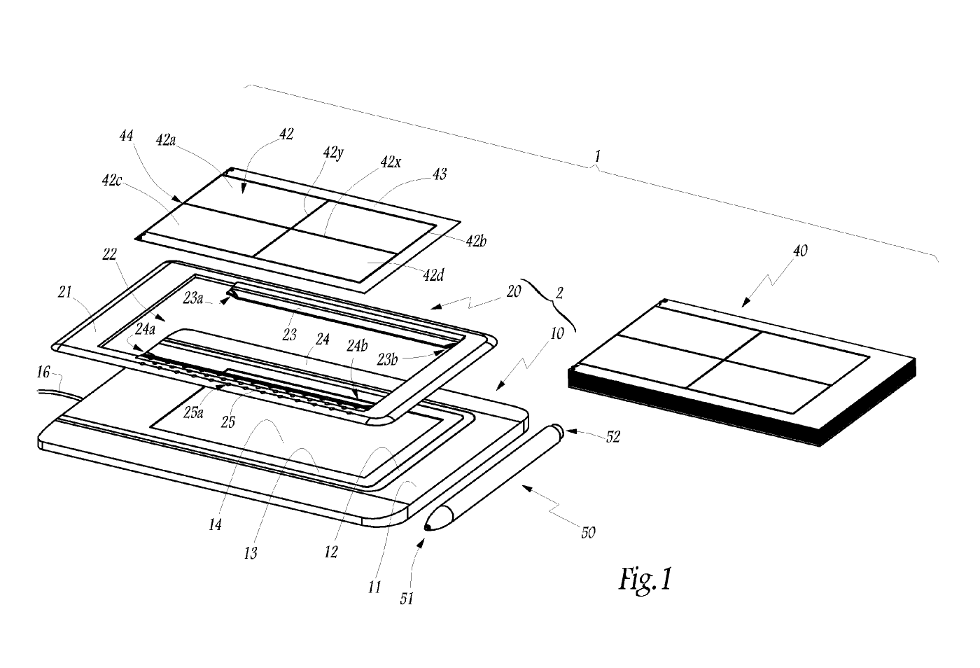

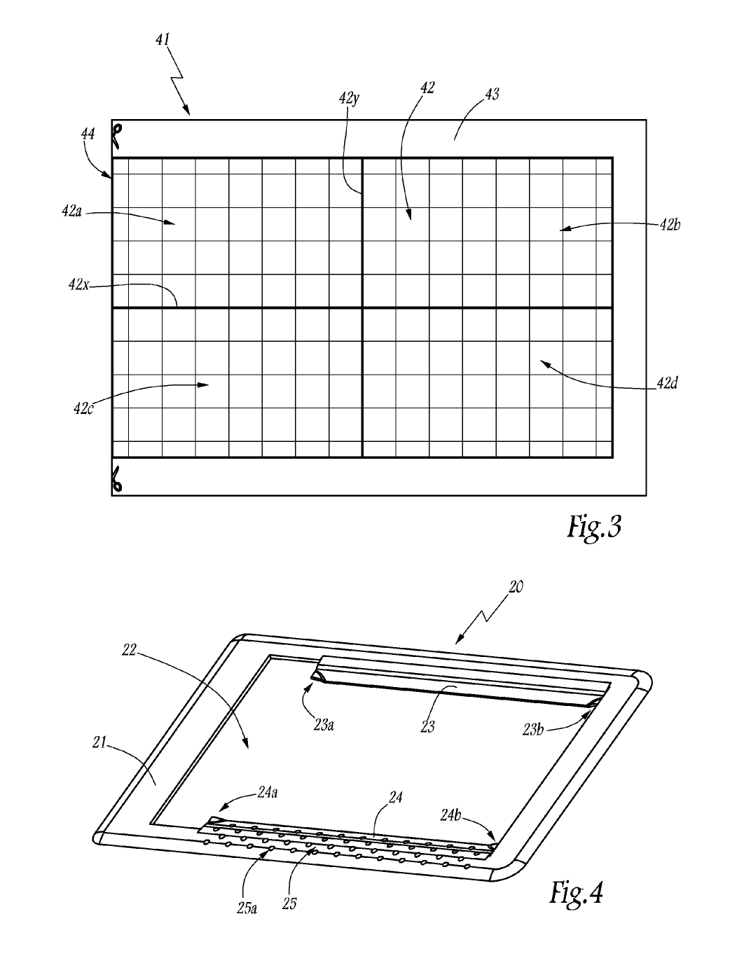

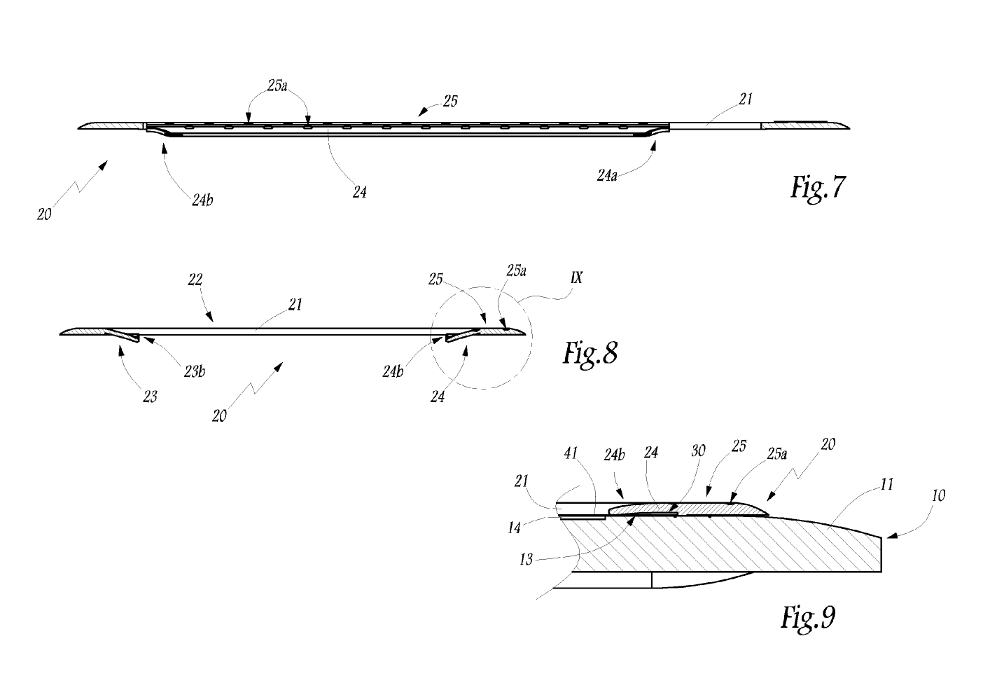

FIGS. 1 to 9 show a writing kit 1 adapted to equip a handwriting reproduction device according to the invention.

The writing kit 1 comprises at least one sheet of paper 41, writing means 50, and a writing tablet 2.

The sheet of paper 41, visible in FIGS. 1 to 3, is detachable from a notepad 40. In practice, the block 40 comprises a large number of sheets 41, for example 100 sheets.

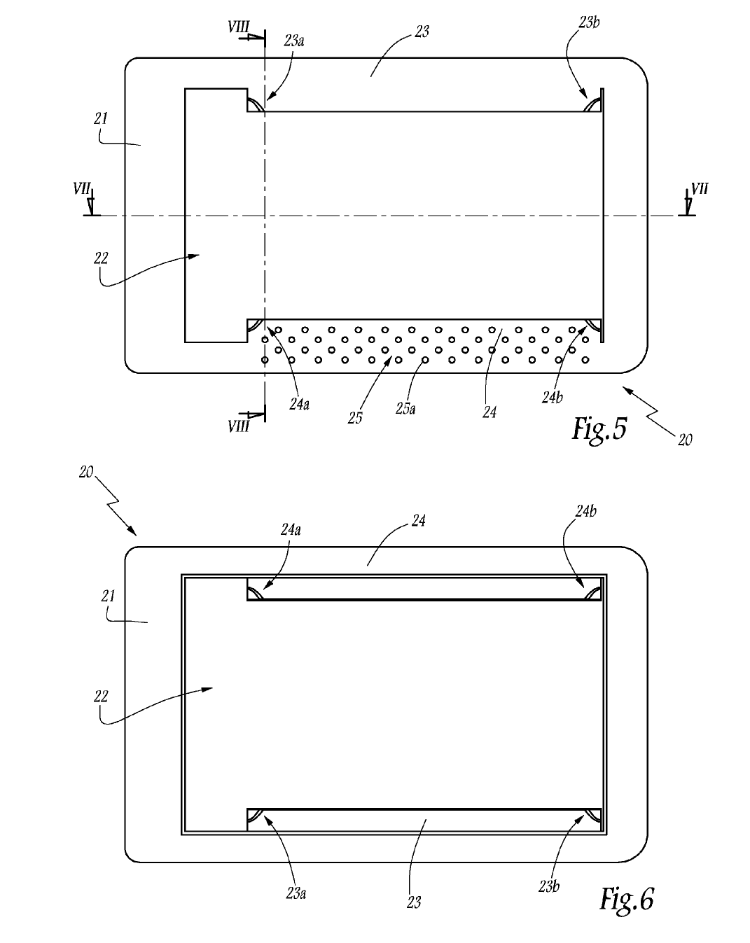

The writing tablet 2 is made up of a graphic tablet 10 and a support 20 for retaining a sheet 41, as shown in FIGS. 1, 2, 4 to 9. In particular, the support 20 is shown alone in FIGS. 5 to 8.

The graphic tablet 10 has a parallelepiped frame 11, in which a working area 12 is delimited. A screen 14 is positioned at the center of the working area 12, with a border 13 on three sides.

In one alternative not shown, buttons may be incorporated into the working area 12, for example on the side of the screen 14 that is provided without a border 13, and make it possible to adjust different parameters of the writing tablet 2 and/or the screen 14. However, the presence of such buttons may complicate the use of the tablet and bother the user while he writes.

In practice, the graphic tablet 10 and the screen 14 may be of any known type, in particular a so-called “graphic” tablet used with certain drawing or layout software. The graphic tablet 10 is equipped with a cord 16 and drivers that allow it to be connected to a computer or data processing means. The graphic tablet 10 also has a recording function and a display function, connected to the screen 14, which constitutes its active surface. For example, the screen 14 may be a liquid crystal touchscreen, a pressure sensor screen, or an electromagnetic screen. The screen 14 is associated with suitable writing means 50, as outlined below.

The support 20 has a frame 21, designed to be positioned on the frame 11 of the graphic tablet 10. Thus, the assembly of the graphic tablet 10 and the support 20 forms the writing tablet 2 according to the invention. The frame 21 of the support 20 is glued on the frame 11 of the graphic tablet 10, at the working area 12, so as to frame the screen 14. The support 20 has a central opening 22 that allows the screen 14 and any buttons to be visible and accessible after positioning of the frame 21. The opening 22 also allows the insertion of a sheet 41 between the support 20 and the screen 14, in the use position.

The support 20 has a first lip 23 and a second lip 24 extending on the two longest opposite sides of the frame 21. The lips 23 and 24 face each other while being turned toward the inside of the support 20, in other words toward the opening 22 and the screen 14, and partially overlap the border 13 and the screen 14. The lips 23 and 24 each have a substantially rectangular profile and extend in directions parallel to the screen 14 when the support 20 is mounted on the graphic tablet 10.

Raised corners 23a and 23b are formed on the first lip 23, while raised corners 24a and 24b are formed on the second lip 24. More specifically, each corner 23a, 23b, 24a and 24b is formed at an end corner of a lip 23 or 24, turned toward the opening 22 and raised opposite the screen 14. In particular, the corners 23a and 24a, which are oriented from the side of the support 20 by which a sheet 41 will be inserted, make it possible to facilitate the insertion.

The frame 21 of the support 20 also has a non-skid surface 25, which is adjacent to the lip 24 designed to serve as support for the user's hand or wrist when he writes on the writing tablet 2. The surface 25 includes a plurality of concave recesses 25a, which have a circular opening and extend slightly below the level of the frame 21. Due to their presence, the surface 25 is not smooth and prevents the user's hand or wrist from sliding. Furthermore, although it has a certain adhesion, the surface 25 is not unpleasant to touch.

The support 20 is made from a material that is elastically deformable under normal use conditions, i.e., between 0° and 40° C., preferably an elastomer. In this way, the lips 23 and 24 have elastic properties and can be easily deformed, on the one hand for positioning the support 20 on the graphic tablet 10, and on the other hand to insert the sheet 41 and maintain it against the screen 14. As shown in FIGS. 8 and 9, after manufacture of the support 20, the lips 23 and 24 are initially folded toward the opening 22. As a result, when the support 20 is fastened on the graphic tablet 10, the lips 23 and 24 are deformed to assume their use configuration. The lips 23 and 24 can be distanced from the screen 14 for insertion of the sheet 41 into the support 20, then returned to their use position by pressing the sheet 41 against the screen 14.

Thus, as shown in FIG. 9, the sheet 41 can be inserted into a housing 30, delimited between the graphic tablet 10 and the support 20. More specifically, the housing 30 shown in FIG. 9 is delimited between the lip 24 and the border 13 of the screen 14. On the other side, not shown in FIG. 9, a similar housing is delimited between the lip 23 and the graphic tablet 10. When it is put in place, the sheet 41 is inserted into the housings 30 and equivalent means and maintained by the lips 23 and 24, and the user can thus write without being bothered by accidental movement of the sheet 41.

In practice, the back of the sheet 41 has a cross-ruled writing area 42, which is partially framed by a border 43 with no pattern. More specifically, the writing area 42 is bordered on three sides of the border 43, and on the last side by a cutting line 44 of the sheet 41 on the notepad 40. The border 43 is designed to position the sheet relative to the support 20, more specifically in the housing 30, between the lips 23 and 24 and the graphic tablet 10. Preferably, as shown in FIG. 3, the sheet 41 is cross-ruled by a set of vertical lines 42x and horizontal lines 42y that define a Cartesian reference and delimit the writing area 42 in different writing locations 42a, 42b, 42c and 42d. Only the median lines 42x and 42y are shown in FIGS. 1, 2 and 10, with four writing locations 42a, 42b, 42c and 42d.

Furthermore, the shape and dimensions of the cross-ruling of the sheet 41 result from an ornamental choice, in particular the arrangement of the lines 42x and 42y, the areas 42a, 42b, 42c and 42d, and the border 43. Alternatively, different cross-rulings may appear on the sheet 41.

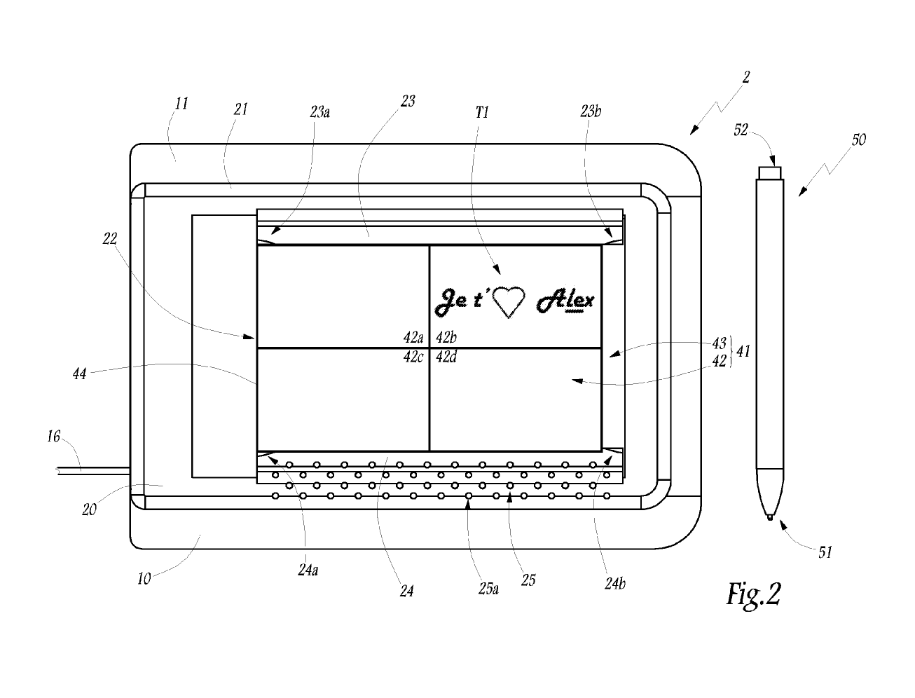

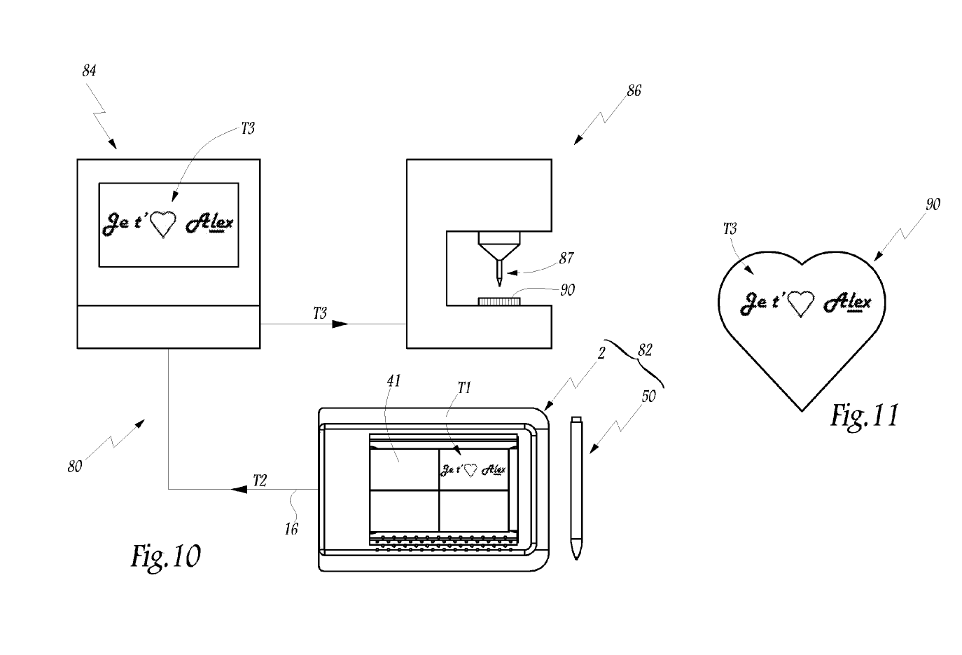

In FIGS. 2 and 10, the handwriting trace T1 is located in the location 42b. According to the example shown is illustration, the trace T1 is: “I love you Alex”, with the word “love” stylized in the form of a heart.

In this way, the sheet 41 makes it possible to perform different functions simply and practically, i.e. the writing support, inking and identification of the writing trace T1. In fact, although it is possible to use the writing tablet 2 without a sheet 41 by writing directly on the screen 14, the presence of the sheet 41 allows the user to write on a paper-type support, and not on the screen 14. This use of the writing tablet 2 is more practical and less destabilizing for a user who is accustomed to paper.

Furthermore, the inking allows the user to view the trace of the writing T1 on the sheet 41 when he writes using the writing means 50. In practice, the inking is done owing to the design of the sheet 41, in the form of independent self-copying paper. Such paper has an auto-reactive surface that is sensitive to pressure, adapted to show the trace T1 during periodic or linear contact, for example with a nail, an awl, a pen or a stylus. In particular, the sheet 41 can include microcapsules of a nature to burst under the pressure of the writing means 50. Thus, the substance contained in the microcapsules is released and forms an image corresponding to the trace T1 in the writing area 42 of the sheet 41 under the effect of the pressure exerted locally with the tip 51 of the writing means 50, whereas that tip does not release a visible substance, of the ink type, when the writing means 50 are used. The microcapsules may contain black ink, or chromogenic agents that react with a developer to form a colored image.

Lastly, the identification of the trace T1 on the sheet 41 may be done owing to the cross-ruling formed by the lines 42x and 42y. This identification is not essential, but makes it possible to facilitate writing by the user by providing him with a visual reference, based on straight lines 42x and 42y, as well as the delimited areas 42a, 42b, 42c and 42d. The cross-ruling also allows complementary identification of the dimensions and position of the trace T1, in particular for its subsequent resizing, as outlined hereafter. However, other cross-ruling configurations may be contemplated according to ornamental considerations.

Preferably, the writing means 50 consist of a digital stylus for a graphic tablet 10, known in itself. Advantageously, the stylus 50 operates without wires or batteries. The stylus 50 is provided with a tip 51, which is pressure-sensitive and adapted to come into contact with the screen 14 of the sheet 41, when the latter is present in the housing 30 of the writing tablet 2. When the user manipulates the stylus 50 to write, he exerts pressure on the tip 51 which, on the one hand, makes the trace of the writing T1 visible on the sheet 41, and on the other hand, makes it possible to record a digital writing trace T2 in the writing tablet 2 using the screen 14, which reacts to a local pressure exerted by the tip 51. This trace T2 may selectively be displayed on the screen 14, but is not visible by the user in the presence of the sheet 41.

In other words, the stylus 50 makes it possible to activate the properties of the autonomous self-copying paper of the sheet 41 that is arranged on the writing tablet 2. In this way, the user can directly view the letter, word, or drawing he has traced with the tip 51 of the stylus 50, as with a traditional pen. Furthermore, the trace T1 is recorded in the form of a data set comprising point coordinates representing the trace T2, which can be transmitted by the writing tablet 2 to the computer or associated data processing means using the cord 16.

The stylus 50 can also have complementary digital functionalities, in particular related to the recording of the trace T2 from the trace T1, as well as the display of the trace T2 on the screen 14. For example, the tip 51 may be of the electromagnetic type for an electromagnetic screen 14, or made from plastic to simply exert pressure on a screen 14 of the pressure sensor type. As a function of the parameterization of the writing tablet 2, the screen 14 can respond to any direct pressure, which may be exerted by the tip 51 or any other means, or respond only to electromagnetic stimuli from the tip 51. Furthermore, the stylus 50 may comprise a digital eraser 52 capable of erasing the trace T2 displayed on the screen 14 and/or on the monitor of a computer associated with the graphic tablet 10, modifying the data set corresponding to T2 at the same time. However, in this case, the eraser 52 cannot erase the trace T1 done on the sheet 41. The stylus 50 may also be provided with buttons, not shown, corresponding to related digital functions.

In practice, the precision of the recording of the trace T2 is determined by the characteristics of the tip 51 of the stylus 50, as well as the characteristics of the screen 14. In fact, the trace T2 recorded by the screen 14 does not reproduce, in a directly exploitable manner, the handwriting done using a traditional pen in the form of the trace T1. Thus, a smoothing processing is applied, described later, to the trace T2 for its exploitation.

In an alternative not shown, the writing tablet 2 may be connected to the writing means 50 by connecting means. For example, the support 20 comprises a boss receiving the end of the spring or a wire, while the other end of the spring or wire is fastened to the writing means 50. According to another example, the frame 11 has a housing for receiving the writing means 50.

In an alternative not shown, the various elements of the support 20 may be arranged in a configuration different from that shown in FIGS. 1, 2, 4 to 9. For example, the lips 23 and 24 may be positioned on the shortest opposite sides instead of the longest opposite sides of the frame 21, or on three sides or four sides.

In an alternative not shown, the support 20 may have a single lip 23 or 24. The insertion of the sheet 41 into the housing 30 is facilitated, but its maintenance is less effective.

In an alternative not shown, according to the configuration and the dimensions of the support 20, the lips 23 and 24, and therefore the housings 30 for receiving the sheet 41, may extend above the frame 11 and/or the screen 14. Preferably, the lips 23 and 24 make it possible to press the sheet 41 against the graphic tablet 10 at the working area 12.

In an alternative not shown, the surface 25 may have any type of projections or recesses capable of giving it a certain roughness, for example grooves, ribs, or any other known means.

In an alternative not shown in FIGS. 1 to 9, the support 20 does not assume the form of a frame 21 with an opening 22 and lips 23 and 24 that delimit a housing 30 for receiving the sheet 41.

In fact, various means for maintaining the sheet may be considered without going beyond the scope of the invention. These maintaining means may be implemented separately or in combination.

Thus, in an alternative not shown, the maintaining means comprise several studs distributed over part of the frame 21 of the support 20, replacing one or two lips 23 and 24, or directly on the frame 11. In that case, the sheet 41 has complementary perforations that allow its positioning relative to the studs, and its maintenance in position against the screen 14.

According to another alternative not shown, the maintaining means comprise a clamp, arranged on the frame 11 of the graphic tablet 10. The sheet 41 is received in the clamp and kept in place against the screen 14, and the maintaining means can also comprise more than one clamp, for example two clamps distributed on two sides of screen.

According to another alternative not shown, the maintaining means comprise a self-adhesive area positioned on the back of the sheet 41. In particular, the self-adhesive area extends over one edge of the back of the sheet 41, corresponding to all or part of the border 43. Furthermore, a non-permanent adhesive is used that makes it possible to position the sheet temporarily, with a repositionable self-adhesive area. In this way, the sheet 41 can be positioned and repositioned easily on the frame 11, against the screen 14. In that case, the block 40 of sheets 41 may not have a cutting line 44, but a stack of self-adhesive areas.

Furthermore, according to another alternative, the sheet 41 is not made from autonomous self-copying paper, but from traditional paper, made with a base of plant fibers. In that case, the writing means 50 may be a traditional pen, for example a ballpoint pen, a pencil, a felt tip pen, or a similar device. Thus, the contact pressure of the writing means 50 on the sheet 41 releases a substance initially included in the writing means 50, which shows the trace of the writing T1 on the sheet 41. However, if the writing tablet 2 is capable of recording the trace T2, such a use can damage the screen 14.

According to another alternative not shown, the writing means 50 may be a modified stylus for a graphic tablet, the tip 51 of which is equipped with a ballpoint tip. In this way, the modified tip 51 can release ink on the sheet of paper 41. Preferably, this ballpoint pen is removable from the tip 51 as chosen by the user.

FIG. 10 shows a writing reproduction device 80 according to the invention.

The device 80 comprises writing acquisition means 82, processing means 84, and writing restitution means 86, which are connected to each other for transmission of digital data, by cabled or wireless connection, in particular owing to the cord 16. A substrate 90 is positioned in the restitution means 86, as outlined below.

The acquisition means 82 comprise at least one writing tablet 2, a sheet 41, and writing means 50, preferably a stylus. In other words, the acquisition means 82 may include all or part of the kit 1 of FIGS. 1 to 9. The acquisition means 82 make it possible to record the trace of the writing T1 in the form of a data set comprising coordinates for points, representing a trace T2. First, the user inserts the sheet of paper 41 under the support 20 of the writing tablet 2, more specifically in the housing 30, against the screen 14. Next, the user writes on the sheet 41 with the stylus 50 and can simultaneously view the trace of the writing T1, which is recorded by the writing tablet 2 in a form T2. Several users can write on the writing tablet 2 successively, without bothering each other or covering the writing of a first user, as they can view the writing of the preceding users on the sheet 41.

Alternatively, the writing tablet 2 does not receive the sheet 41, the user(s) write on the screen 14, and the trace T2 is displayed directly on the screen 14 or by the processing means 84. This use is less practical and advantageous, but not impossible to implement. In fact, this possibility allows a certain versatility of the writing tablet 2. Furthermore, the device 80 does not become unusable if it simply lacks the sheet 41, or in the event of an out-of-stock of notepads 40 comprising sheets 41.

At the same time as the recording, in real-time from the user's point of view, the processing means 84 receive the data set recorded by the writing tablet 2 that represents the trace T2. Preferably, the processing means 84 comprise a computer, with a monitor capable of displaying a transformed trace T3. Initially, the trace T3 may be identical to the recorded trace T2, then is made to undergo various processing operations. In fact, at this stage, the recording of the trace T2 by the writing tablet 2 is not directly exploitable to be able to reproduce the handwriting with sufficient quality and aesthetics, close to those of the trace T1.

Thus, the processing means 84 can apply one or more processing operations to the data set recorded by the acquisition means 82, automatically or as chosen by the user, in order to obtain a transformed trace T3 for the reproduction thereof. In practice, the processing implement calculation algorithms, capable of converting the input data into exploitable output data. A software application associated with processing means 84 includes the different calculation algorithms, as well as a user interface. The processing begins with the acquisition of data recorded by the writing tablet 2 and corresponding to T2, and ends with the transmission of processed data to the writing restitution means 86, in the form of a trace T3 transformed for the reproduction thereof.

In particular, the processing may comprise smoothing of the coordinates of points representing T2, in order to improve the quality of the transformed trace T3 and bring it closer to the handwriting corresponding to T1. More specifically, the screen 14 captures points that approximately correspond to the trace T1 in order to form the trace T2: with too many captured points, the rendering of the trace T2 is “shaky,” but by eliminating points, the rendering of the trace T2 assumes the form of a relatively unharmonious assembly of segments. It is thus necessary to smooth the profile drawn by the points that make up the trace T2, without eliminating or adding them to fill in the trace T2. In practice, such a smoothing algorithm is known in the image processing field, but the smoothing treatment is nevertheless optimized for the present application.

The processing may also comprise automatic reframing of the transformed trace T3, in particular re-centering. The processing may also comprise resizing of the trace T3 to the dimensions of the substrate 90, as a function of the information filled in by the user. To that end, owing to the cross-ruling of the sheet 41, the identification of the dimensions and the position of the initial trace T1 is facilitated. Furthermore, during the recording of the trace T2, it is possible to consider identifying two extreme points of the trace T1, for example a point situated in the top right and a point situated in the bottom left of the trace T1. Additionally, the processing may be capable, from the single-line trace T2, of creating a writing trace T3 with two lines, three lines, bold lines, shadowing, or artistic writing. In general, any type of artistic effect may be considered.

Furthermore, using the software, the processing may consist of a combination of handwriting of the trace T1 with computer text and/or an image, for example a photograph or a logo. The text is typed on the computer, or chosen from among a panel of examples offered to the user, for example “happy birthday” or “Merry Christmas.” The image may be chosen from a gallery of the clipart type, or loaded from a portable data medium belonging to the user, such as a mobile telephone or a USB key. The relative positioning of the handwriting with the text and/or image may be modified simply. Furthermore, the combination may include several texts, several images, and several handwriting traces.

Thus, different visual effects may be considered without going beyond the scope of the invention.

Alternatively, the processing means 84 make it possible to select only part of the transformed trace T3 so as to apply processing to it, such as a smoothing filter, resizing, erasure, or an artistic effect.

Once the processing operation(s) applied have been validated by the user, the processing means 84 transmit the processed data to the writing restitution means 86, so as to reproduce the transformed trace T3. In practice, the restitution means 86 comprise a device equipped with a marking tool 87, which can restitute the transformed trace T3 by marking on the substrate 90.

For example, the tool 87 shown in FIG. 10 is a tip adapted for scratching the substrate 90. The scratching tip 87 may be made from diamond or include a carbide coating, for example metal carbide.

Alternatively, the tool 87 may be a laser making it possible to perform laser marking on the substrate 90. The laser may be of any type suitable for the application.

According to another alternative, the tool 87 may be suitable for machining the substrate 90.

According to another alternative, the tool 87 may be a firing pin, more specifically a micro-firing pin making it possible to mark the substrate 90 by micro-striker, in particular a pneumatic or electromagnetic striker.

According to another alternative, the tool 87 may be an ultrasonic stylus.

According to another alternative, the tool 87 may be a heating tip for heat marking, or a heating tip associated with a heat transfer strip.

According to another alternative, the tool 87 may be a sewing machine needle for performing the marking on a fabric.

According to another alternative, the tool 87 may be a printing head for a printer, for example a needle or a series of needles.

FIG. 11 shows the substrate 90 after marking. The substrate 90 is heart-shaped and the trace T3 has been reproduced on its surface.

In practice, the substrate 90 is a medium adapted to receive a marking, for example made from metal, coated or uncoated metal alloy, plastic, organic matrix composite, glass, wood, leather, cardboard, paper, stone, fabric, or a mirror. In particular, the substrate 90 is an object that the user of the device 80 wishes to customize, for example jewelry, a mobile telephone shell, a perfume bottle, a mailbox plate, an electronic device, a portable music device, a leather item, a cosmetic product, a pillbox, a lighter, a pen, a mirror, a glass, etc. The substrate 90 may be two-dimensional or three-dimensional.

Certain tools 87 are suited to a large number of substrates 90, while certain substrates 90 may require a particular tool 87. Advantageously, the restitution means 86 are versatile and configured to receive different types of substrates 90, which may in particular assume different forms and different dimensions.

Furthermore, to make it possible to adapt the dimensions of the trace T2 to the dimensions of the object 90, it is necessary to provide these dimensions to the processing means 84. To that end, the user can fill in the known or estimated dimensions of the object 90 in the processing means 84, for example by choosing the suitable dimensions on a monitor.

Alternatively, the dimensions of the object 90 may be detected automatically by the restitution means 86 in which the object 90 is positioned. In other words, the restitution means then comprise an automatic detection system for the dimensions and/or the position of the object 90.

According to one alternative embodiment of the device 80 of FIG. 10, the processing means 84 are directly integrated into the restitution means 86.

According to another alternative embodiment of the device 80, the means 82, 84 and 86 form a unitary assembly, which is more compact while remaining easy to use.

Thus, the writing reproduction device 80 can be implemented to customize all types of objects 90, directly in the purchase store, or in a specialized workshop or boutique. Owing to the device 80, it is possible to obtain continuous and aesthetic writing close to handwriting. The use of the device 80 is facilitated by the presence of the writing kit 1, in particular the writing tablet 2 and the sheet 41, allowing a non-specialist to write and draw while seeing what he writes or draws.

1. A device for reproducing handwriting comprising a handwriting acquisition device recording, when a user writes on the handwriting acquisition device with a writing implement, a handwriting trace in the form of a set of data including coordinates of points of a digital trace, said handwriting acquisition device comprising at least one writing kit (1) including:
the writing implement provided with a tip,
a writing tablet comprising a frame and an active surface which is disposed in the frame and which records the handwriting trace in the form of a set of data corresponding to the digital trace when a user writes on the tablet with the writing implement means,
at least one sheet adapted to react locally to pressure from the tip, and
maintaining device maintaining the sheet in the use position against the surface,
wherein the device includes:
a processor configured to subject the set of data corresponding to the digital trace to at least one processing operation in order to obtain a transformed trace, and
a writing restitution device comprising an apparatus provided with a marking tool and configured to restitute the set of data processed by the processing means by marking the transformed trace on a substrate.

2. The device according to claim 1, wherein the maintaining device comprises a medium arranged on the tablet, the medium extending around the active surface over at least part of the frame and being able to maintain the sheet in the use position against the active surface.

3. The device according to claim 2, further comprising a support made from a deformable material, in particular elastomer, and delimits, with the frame, at least one housing for receiving an edge of the sheet and maintaining the sheet in the use position against the active surface.

4. The device according to claim 2, further comprising a support that comprises at least one deformable lip bearing against the frame and/or the active surface and that can be at least partially moved away from the frame and/or the active surface for the insertion of one edge of the sheet between said lip and at least one of the frame and the active surface.

5. The device according to claim 1, wherein the maintaining device comprises at least one clamp arranged on at least one of the tablet and at least one self-adhesive surface arranged on the sheet and several studs arranged on the tablet while the sheet has perforations complementary to the studs.

6. The device according to claim 1, wherein the processor comprises a smoothing algorithm for a profile drawn by the coordinates of points making up for digital trace without eliminating points.

7. The device according to claim 1, wherein the writing restitution device is capable of receiving different types of substrates, in particular having different shapes or different dimensions.

8. The device according to claim 1, wherein the writing restitution device comprises at least one of the following tools: drill, scratching tip, micro-striker, laser, ultrasonic stylus, heating tip for hot marking, heating tip associated with a heat transfer strip, sewing machine needle or printer pins.

9. The device according to claim 1, wherein the writing restitution device comprises a system for automatically detecting at least one of the dimensions and position of the substrate.

10. The device according to claim 1, wherein the writing implement do not release a visible substance and the sheet is a self-copying paper, such that, when the user writes with the writing implement on a sheet positioned in the tablet, the bearing pressure of the writing implement on the sheet releases a substance initially included in the sheet that shows the trace of the writing on the sheet.

11. The device according to claim 1, wherein each sheet is made from a non-self-copying paper and wherein the writing implement can release a visible substance, such that when a user writes with the writing implement on a sheet positioned in the tablet, the bearing pressure of the writing implement on the sheet releases a substance initially included in the writing implement that shows the trace of the writing on the sheet.

12. A writing tablet provided with an active surface that is positioned in a frame and that records a handwriting trace in the form of a set of data corresponding to a digital trace when a user writes on the tablet with writing implement, wherein the tablet belongs to a writing kit of a handwriting reproduction device according to claim 1 and wherein the tablet also comprises a support, which extends around the active surface over at least part of the frame and is capable of maintaining a sheet in the in use position against the active surface.

13. A method for implementing a handwriting reproduction device, comprising a writing acquisition device, a processor, and a writing restitution device, the method comprising the following steps:
a writing step, writing acquisition device using a writing implement, and at the same time viewing the trace of the writing on the writing acquisition device,
a writing acquisition step, recording, with the writing acquisition device, the trace of the writing in the form of a set of data that includes coordinates for points corresponding to the digital trace, the acquisitions being carried out at the same time as the writing step,
a processing step, processing the data set corresponding to the digital trace to obtain a transformed trace, and
a writing retrieval step, marking with the writing restitution device of the transformed trace on the substrate.

14. The method according to claim 13, wherein at least one processing operation in the processing step comprises the step of at least one of smoothing, resizing, reframing, duplication, or a fantastical effect.

15. The method according to claim 13, wherein the processing step comprises automatic smoothing processing that is done at the same time as the writing and writing acquisition steps and, at least one processing operation chosen by the user.
